(19) United States
(12) Patent Application Publication
(10) Pub. No.: US 2006/0200763 A1
(43) Pub. Date: Sep. 7, 2006

(54) Technique for exporting document content

(76) Inventors: Alexander Michaelsen, Heidelberg (DE); Michael Igelbrink, Sandhausen (DE); Irina Goetzenberger, Heidelberg (DE); Lorenz E. Wiest, Walldorf (DE)

Correspondence Address: FISH & RICHARDSON, P.C., PO BOX 1022, MINNEAPOLIS, MN, 55440-1022, US

(21) Appl. No.: 11/073,329

(22) Filed: Mar. 4, 2005

(51) Int. Cl. G06F 17/24

(52) U.S. Cl. 715/523

(57) ABSTRACT

Techniques are described for converting content within a document from a first format to a second format using an intermediate format. In one variation, a technique obtains layout data associated with content in a source document having a first format, sequentially converts portions of the content into an intermediate format based on the layout data, and exports the intermediate format content into a target document having a second format based on predetermined spatial layout restrictions.

### BACKGROUND

A document viewer, such as a browser, may be used to access local content or content distributed on networks, such as the Internet or an internal corporate network. When content of interest has been accessed in the document viewer, problems arise when printing or otherwise exporting the content to another document format. Depending on the size of the content, portions of the content may be scaled or divided across several pages in a manner that is difficult to use. In particular, tables contained within a document are often arbitrarily divided within a column or row, making it difficult to view the resulting table. Similar problems exist when viewing or otherwise exploiting other types of exported content.

### SUMMARY

In one variation, a method comprises obtaining layout data associated with content in a source document having a first format, sequentially converting portions of the content into an intermediate format based on the layout data, and exporting the intermediate format content into a target document having a second format based on predetermined spatial layout restrictions.

The method may also include identifying content within the source document. However, the content may be identified prior to the implementation of the method. Similarly, the method may alternatively or additionally comprise determining spatial layout restrictions for the content within the target document although such layout restrictions may be determined beforehand. The spatial layout restrictions may be based on a printing or viewing area associated with target documents or other criteria.

The method may take into account numerous factors of both the content and the target document when exporting the document. The factors may determine in which fashion the content is provided in the target document. For example, the method may divide the content in the intermediate format and export the divided content onto more than one page of the target document. The method may select identifiers (e.g., row designators, column designators, headers, and footers) associated with the content to be carried over to more than one page of the target document, and carry over the selected identifiers to more than one page of the target document. In some variations, the method may comprise scaling the content to fit within a single page of the target document or scaling the content to fit within a predetermined vertical or horizontal dimension. This scaling may include changing the size of sub-components within the content (e.g., cells within a table) or changing the size of text (e.g., font size).

The content exported may be any embodiment of data desirable to export to a target document. Content might include audio-visual data as well as information such as layout containers, text, macros, graphs, charts, images, tables, page breaks, and page descriptions. If the content is a table, the method may sequentially convert rows or columns of the table into the intermediate format. The method may also comprise mapping the table to a table template in the target document. Other templates may be utilized for varying types of content other than tables.

The layout data obtained may include one or more of row designators, column designators, headers, footers, color, background color, cell color, column span widths, row heights, page descriptions, page size, size of content area, header description, footer description, type of content, and the like. Portions of the content data may be selectively converted based on the received layout data. Optionally or in addition to, the method may also include converting requests portions of the content data based on processing or memory consumption levels. With this variation, if the burdens on the memory or processors are too great, then the sequential amounts of content to be converted may be decreased in size.

In another variation, an apparatus comprises an acquisition unit to obtain layout data associated with content in a source document having a first format, a conversion unit to sequentially convert portions of the content into an intermediate format based on the layout data, and an export unit to export the intermediate format content into a target document having a second format based on predetermined spatial layout restrictions.

Computer program products, which may be embodied on computer readable-material, are also described. Such computer program products include executable instructions that cause a computer system to conduct one or more of the method acts described herein.

Similarly, computer systems are also described that may include a processor and a memory coupled to the processor. The memory may encode one or more programs that cause the processor to perform one or more of the method acts described herein.

The details of one or more variations of the subject matter described herein are set forth in the accompanying drawings and the description below. Other features, objects, and advantages of the subject matter described herein will be apparent from the description and drawings, and from the claims.

### BRIEF DESCRIPTION OF THE DRAWINGS

These and other aspects will now be described in detail with reference to the following drawings.

FIG. 1 illustrates a method for exporting content within a source document into a target document;

FIG. 2 illustrates an apparatus to export content within a source document into a target document;

FIG. 3 illustrates a block diagram of a communications system useful for understanding and implementing the subject matter described herein;

FIG. 4 illustrates an export mechanism useful for understanding and implementing the subject matter described herein;

FIG. 5 illustrates a block diagram useful for understanding and implementing the subject matter described herein;

FIG. 6 illustrates an initial table to be exported into a second document format;

FIG. 7 illustrates a first sample conversion of the initial table of FIG. 6 into the second document format;

FIG. 8 illustrates a second sample conversion of the initial table of FIG. 6 into the second document format;

FIG. 9 illustrates a third sample conversion of the initial table of FIG. 6 into the second document format; and

FIG. 10 illustrates a fourth sample conversion of the initial table of FIG. 6 into the second document format.

### DETAILED DESCRIPTION

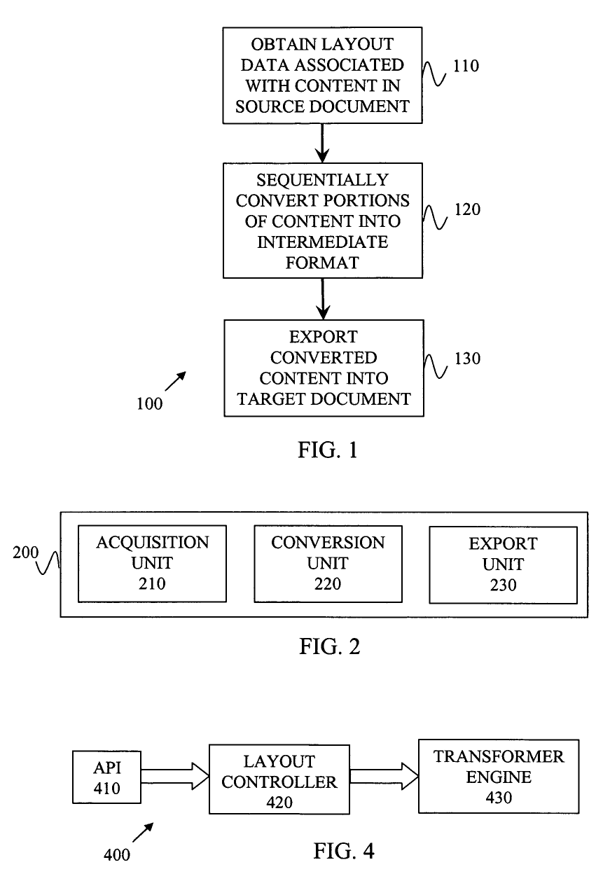

FIG. 1 illustrates a method 100 that may commence at step 110, with obtaining layout data associated with content in a source document having a first format. Thereafter, at step 120, the method may continue with sequentially converting portions of the content into an intermediate format based on the layout data. The method may also include, at step 130, exporting the intermediate format content into a target document having a second format (which is different than the first format) based on predetermined spatial layout restrictions.

FIG. 2 illustrates an apparatus 200 that may include an acquisition unit 210 to obtain layout data associated with content in a source document having a first format. The apparatus may also include a conversion unit 220 to sequentially convert portions of the content into an intermediate format based on the layout data as well as an export unit 230 to export the intermediate format content into a target document having a second format based on predetermined spatial layout restrictions.

The following provides optional variations useful for understanding and implementing the invention. These variations may practiced singly or in combination depending on the desired configuration. While the foregoing generally describes exporting tables, it will be appreciated that other forms of content may be converted and exported based on the methodologies of the subject matter described herein.

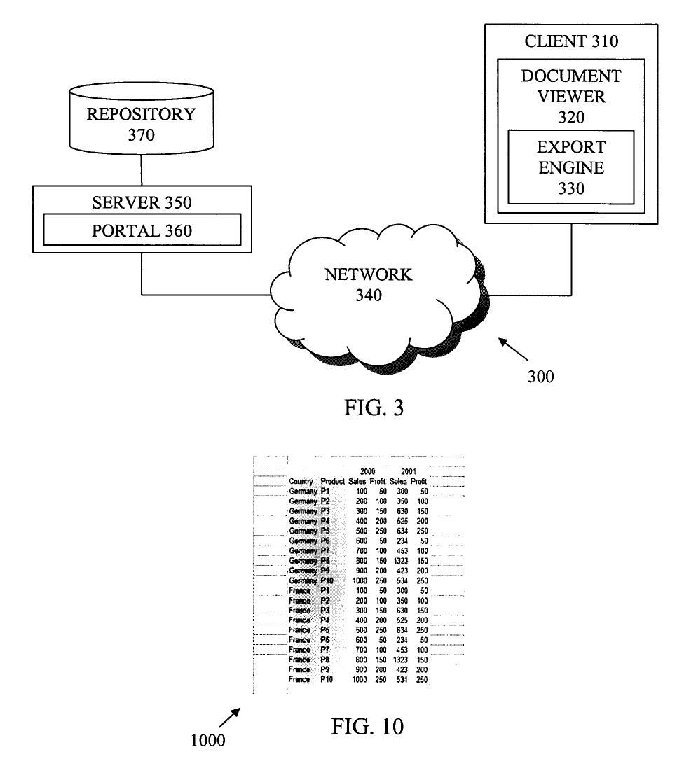

FIG. 3 illustrates a communications system 300. Communications system 300 represents a network of a corporate enterprise. A user (e.g., employee) may employ a client 310 to access resources (e.g., corporate data, corporate applications, Internet resources) using communications system 300. Client 310 may execute a document viewer 320 to access and interface with the network resources. The document viewer 320 may be a browser or other application which allows a user to access content within a document. The content may be provided across several pages or it may be provided on a single page. The amount of content displayed at any one time is typically contingent on the size of a window in which the document viewer is executing and/or the size of a page. The size of a page may be contingent upon on a printing size (such as with a word processing program) or it may have a non-fixed size (such as a web page). If the content is larger than the window size, then a graphical user interface within the document viewer 320 may include user interface objects such as scrolling element or arrows which allow a user to navigate to sections of the content that do not fit within the window. The document viewer 320 also includes an interface to allow a user to select portions of the content for printing or for exporting.

Document viewer 320 initially communicates with a corporate portal 360, executing on a server 350, via a network 340. Network 340 may be, for example the Internet, the enterprise intranet, and the like. Portal 360 obtains a document from a document repository 370 and generates and transmits an initial document to client 310 via the network 340. Content within the initial document may be viewed at the client 310 via the application 320. Thereafter, the content may be exported to a different document format using an export engine 330 (which may be internal or external to the application 320).

The content displayed within the document viewer 320 may include a table having rows and columns of data. Depending on the complexity of the information provided within the initial document, the table may have large numbers of rows and columns. For printing, the export engine 330 allows a selected table to fit onto one or more standard page of papers without cutting off parts of the table (thereby ensuring that the printed product is usable). In addition, the document viewer 320 also allows a user to select a portion of the table so that the export engine 330 may print out portions of the table. Similar adjustments may be made to fit the content within a defined page size of a document having a different format than that of the initial document.

In one variation illustrated in FIG. 4, an export mechanism 400 is provided. The export mechanism 400 first describes the document and its contents. The export mechanism 400 calculates the sizes necessary for the table and text, including font and cell sizes, to make the table fit on the page or across several pages. The strategies for fitting the page for export include resizing and changing the font of the text or distributing the contents of the report on several pages include a “wallpaper” mode. Cell size may also be adjusted to fit the table within a predetermined size.

In the wallpaper mode, the table is distributed across several pages in such a way that they may be arranged, e.g., pinned to a wall, to show the full table. Additionally, if a table is distributed across multiple pages, additional identifiers, such as page numbers or column/row combinations, may be added that would be useful in associating the various pages. These identifiers may be particularly useful when a table is divided into a large number of pages.

The export mechanism 400 consist of three parts: an application programming interface (API) 410 to create a format independent export model (e.g., an intermediate format document), a layout controller 420 that calculates the page breaks and controls the rendering of the model content, e.g. repeating of table headers, and a transformer engine 430 that creates the export format.

The API 410 creates a format-independent export model (e.g., intermediate format document) (in memory). The API 410 may define the size of the page in which the content is presented, size of the content area, header and footer information (e.g., text, macros, images), and the API 410 may define the content. For tables, layout and data may be separated. For example, the layout description for rows might only be defined once and only data that is needed for a row is requested via iterators. The separation of layout and data may reduce the amount of data that has to be transported. Table information will be delivered separated in layout and data.

In the document a default page description may be set. This default page description may be overwritten later in the export model, for example, to support another orientation (e.g., landscape v. portrait).

Export model content objects may include: layout containers (flow, grid), text, macros (Page No., Date, . . . ), images, tables, page breaks, page descriptions, and the like. To minimize resource usage, the table is not added to the export model as a full instantiated block. To add a table as content to the export model the user may implement an ITable interface.

The ITable interface represents a table object. It may consists of two routines:

```
Interface ITable {
    public ITableContentIterator getRowIterator( );
    public ITableTemplate getTableTemplate( );
}
```

The method getTableTemplate returns the layout descriptions of the table. The TableFactory.createTableTemplate( ) may be used to create an instance of ITableTemplate. Then ITableTemplate may be used to create layout descriptions and data instances of the table. The export framework may call ITable.getRowIterator( ) to get a sequential access to the rows of the table.

A table template may be grid-based, i.e., consisting of rows and columns. The template may contain a set of row templates. A row template contains n cells templates, each cell template being based on format of data in the content (e.g., text or images). A cell template may contain information defining background color, borders, row heights, static columns spans, and the like. Additionally or in the alternative, a column template may be utilized in a similar fashion.

Each row template may include level information. This level information may be used by a layout controller to repeat the latest n level on the next page. Through that, header and group level information may be repeated on the next page.

To create a real row instance in the model the createInstance method of a row template may be used. Then the data for the cell contents may be set, e.g., for an instance of a cell, a dynamic row span may be set. In addition, forced page breaks may be added to the export model.

Special additional layout strategies may be used for tables, e.g., repeat block levels, set of levels to support header/group level, repeat key columns, and the like.

The iterative and/or template approach may help reduce the amount of data that has to be held in memory and/or to reduce processor consumption. Such reductions are particularly important when exporting content such as tables with hundreds or thousands of rows. For small tables, a table class that can be filled in an easier manner may be offered.

The layout controller 420 may take the export model and calculate the size needed for the content. If the content does not fit on one page (as defined by the source document format) then the controller uses a layout strategy to create a plan (model) to distribute the content on several pages. Thereafter, the layout controller 420 may calls the transformer engine 430 for each page to generate the export format. Finally the layout controller 420 calls the transformer engine 430 to return the created document.

Layout strategies (calculation page breaks, page content) may include (a) fit to horizontal size, (b) fit to one page, and (c) wallpaper, with the restriction that cells and images are atomic and will be not distributed on several pages. Also, no repeating of headers, levels, and key columns may be utilized. Compensations may be taken into account for image sizes that change during runtime. In addition, compensations due to the changes in the layout of the table component must be taken into account (e.g., reducing the width of the report by reducing the with of the columns and/or by using a smaller font).

In one variation, the transformation engine 430 may transform the export model to PDF, PostScript™ (PS) and PCL the Adobe Document Service™ (ADS) may used. Other transformation engines may be used to transform into different formats, e.g., Excel™, Microsoft Powerpoint™, and Microsoft Word™. The result may be a binary stream (getStream), such as a MIME type, to visualize the transformed table in the browser, e.g., Acrobat Reader™ for PDF documents. In one variation, the visualization step may be skipped and the transformed table printed directly or sent as an email attachment to one or more recipients.

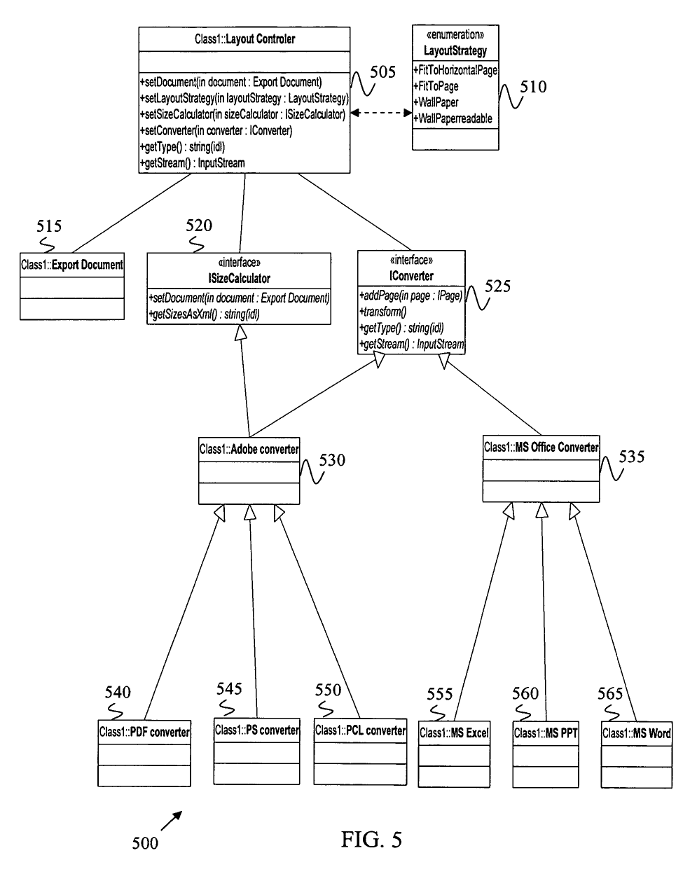

FIG. 5 is a block diagram 500 providing a sample layout controller 505 useful for understanding and implementing the subject matter described herein. The layout controller 505 may obtain an export document (e.g., an intermediate format document) from an export document unit 515. Layout strategy may be obtained by the layout controller 505 from a layout strategy unit 510. The layout strategy may include, for example, which mode to utilize in order to export the document, including whether to fit to a horizontal page dimension, whether to fit to a page, whether to wallpaper the content within the export document without repeating headers, levels, and key columns, and whether cell and images are atomic and will not be distributed on several pages.

A size calculator unit 520 may be coupled to the layout controller 505 and provides information regarding layout restrictions within a desired format. The size calculator unit 520 may be coupled to an Adobe™ converter unit 530 that is in turn coupled to a PDF converter unit 540 to provide layout restrictions and conversion information for portable document format documents, a PS converter unit 545 to provide layout restrictions and conversion information for PostScript format documents, and a PCL converter unit 550 to provide layout restrictions and conversion information for printer control language format documents.

Also coupled to the layout controller 505 is a converter unit 525. The converter unit 525 provides information regarding page structures and may be coupled to the Adobe™ converter unit 530 as well as an Microsoft™ converter unit 535. The Microsoft™ converter unit 535 may in turn be coupled to an MS Excel™ unit 555 to provide layout restrictions and conversion information for Microsoft Excel™ format documents, an MS PPT™ unit 560 to provide layout restrictions and conversion information for Microsoft PowerPoint™ format documents, and an MS Word™ unit 565 to provide layout restrictions and conversion information for Microsoft Word™ format documents.

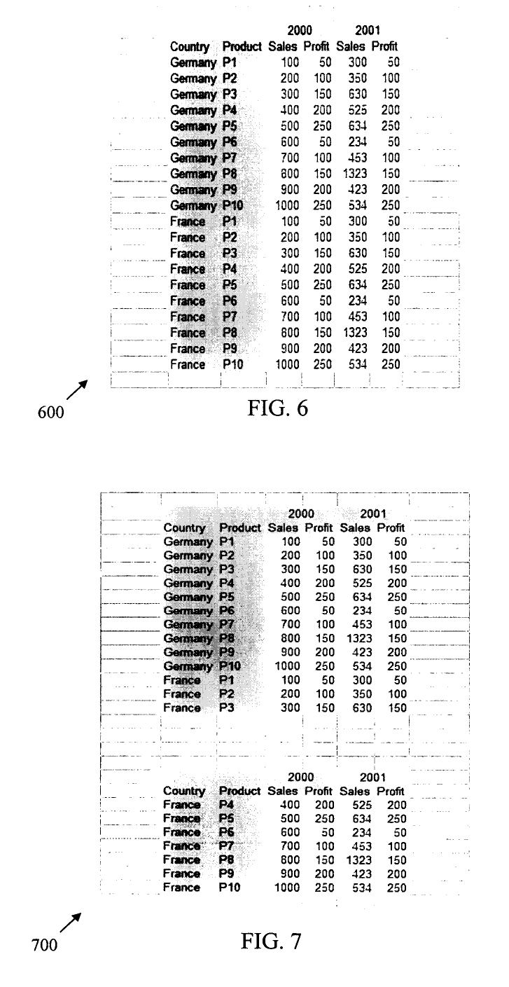

FIGS. 7-10 illustrate the results of exporting an initial table 600 shown in FIG. 6 of a first format into a second format in accordance with the techniques described herein. If the width of the initial table 600 is compatible with the second format, but the height is too large, a converted table 700, as shown in FIG. 7, may include two portions with column designations (e.g., identifiers) carrying over to both portions. The converted table 700 may also include cell and font size downsizing to ensure that the table fits within a horizontal dimension.

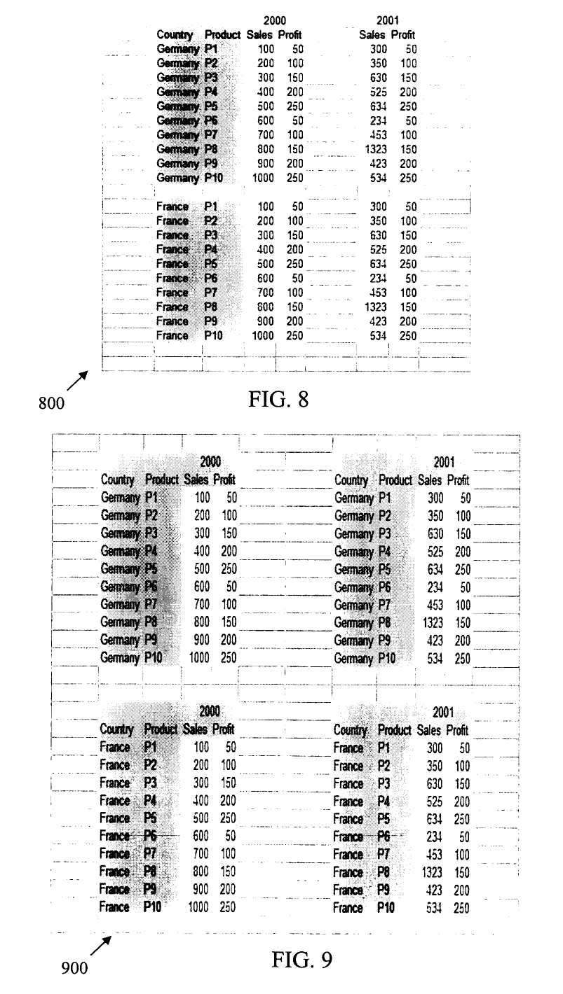

If the height and width of the initial table 600 are too great for the second format, then the initial table 600 may be divided into multiple portions. In one variation shown in FIG. 8, a converted table 800 is a quartered version of initial table 600 extending over four pages. Column and row designations are not carried over to the additional pages and no downsize of content needs to be made.

In another variation shown in FIG. 9, a converted table 900 is also a quartered version of initial table 600 extending over four pages. However, this table 900 carries over both column and row designators to the additional pages (and optionally without downsizing cell or font size). For example, each section includes the column designator Country, Product, Sales Profit, and the row indicators listed under Country and Product.

Alternatively, the initial table 600 may be converted such that it fits within a single page of the second format, such as converted table 1000 shown in FIG. 10. The converted table 1000 may be reduced or enlarged in one or both of the height and width dimensions depending on the desired configuration and depending on any size or other layout restrictions in the second format. The reduction or enlargement may be accomplished by adjusting the cell size and/or the font size.

Various implementations of the systems and techniques described herein may be realized in digital electronic circuitry, integrated circuitry, specially designed ASICs (application specific integrated circuits), computer hardware, firmware, software, and/or combinations thereof. The various implementations may include one or more computer programs that are executable and/or interpretable on a programmable system including at least one programmable processor, which may be special or general purpose, coupled to receive data and instructions from, and to transmit data and instructions to, a storage system, at least one input device, and at least one output device.

The computer programs (also known as programs, software, software applications or code) may include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the systems and techniques described here), or any combination of such back-end, middleware, or front-end components. The components of the system may be interconnected by any form or medium of digital data communication (e.g., a communication network). Examples of communication networks include a local area network (“LAN”), a wide area network (“WAN”), an intranet, the Internet, and wireless networks, such as a wireless WAN.

The computing system may include clients and servers. A client and server are generally remote from each other and typically interact through a communication network. The relationship of client and server arises by virtue of computer programs running on the respective computers and having a client-server relationship to each other.

Although only a few embodiments have been described in detail above, other modifications are possible. For example, the logic flows depicted in FIG. 1 do not require the particular order shown, or sequential order, to achieve desirable results. In certain implementations, multitasking and parallel processing of the parameters may be preferable. In addition, the content for exporting from a first format to a second format may be local content and need not derive from an external network node. Moreover, the content may be taken from any document format in which a visual representation is presented to a user. Nevertheless, it will be understood that other modifications may be made without departing from the scope of the subject matter described herein. Other variations may be within the scope of the following claims.

What is claimed is:

1. A computer-implemented method comprising:
obtaining layout data associated with content in a source document having a first format;
sequentially converting portions of the content into an intermediate format based on the layout data; and
exporting the intermediate format content into a target document having a second format based on predetermined spatial layout restrictions.

2. A method as in claim 1, further comprising identifying content within the source document.

3. A method as in claim 1, further comprising determining spatial layout restrictions for the content within the target document.

4. A method as in claim 1, further comprising dividing the content in the intermediate format and exporting the divided content onto more than one page of the target document.

5. A method as in claim 4, further comprising:
selecting identifiers associated with the content to be carried over to more than one page of the target document; and
carrying over the selected identifiers to more than one page of the target document.

6. A method as in claim 5, wherein the identifiers are chosen from a group comprising: row designators, column designators, headers, and footers.

7. A method as in claim 1, further comprising scaling the content to fit within a single page of the target document.

8. A method as in claim 1, further comprising scaling the content to fit a predetermined vertical or horizontal dimension.

9. A method as in claim 1, wherein the content is a table.

10. A method as in claim 9, wherein the converting sequentially converts rows or columns of the table into the intermediate format.

11. A method as in claim 9, further comprising mapping the table to a table template in the target document.

12. A method as in claim 1, wherein the layout data is chosen from a group comprising: page descriptions, dimensions, row designators, column designators, headers, footers, color, background color, cell color, column span widths, and row heights.

13. A method as in claim 12, wherein the page description contains information chosen from the group comprising: page size, size of content area, header description, footer description, and type of content.

14. A method as in claim 1, wherein the converting requests portions of the content data based on processing or memory consumption levels.

15. A method as in claim 1, wherein the content includes objects chosen from the group comprising: layout containers, text, macros, images, tables, page breaks, and page descriptions.

16. A method as in claim 1, wherein the predetermined spatial layout restrictions are based on at least one of a page size, printing area, or a viewing area.

17. A method as in claim 1, further comprising visualizing the target document with the exported intermediate format content.

18. An apparatus comprising:
an acquisition unit to obtain layout data associated with content in a source document having a first format;
a conversion unit to sequentially convert portions of the content into an intermediate format based on the layout data; and
an export unit to export the intermediate format content into a target document having a second format based on predetermined spatial layout restrictions.

19. The apparatus of claim 18, further comprising means for identifying the content in the source document.

20. A computer program product, embodied on computer readable-material, that includes executable instructions for causing a computer system to:
obtain layout data associated with content in a source document having a first format;
sequentially convert portions of the content into an intermediate format based on the layout data; and
export the intermediate format content into a target document having a second format based on predetermined spatial layout restrictions.
